(19) United States
(12) Patent Application Publication
(10) Pub. No.: US 2006/0014569 A1
(43) Pub. Date: Jan. 19, 2006

(54) Mobile communication device with adaptive audible user notification

(75) Inventor: Matthew DelGiorno, Portola Hills, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 10/889,047

(22) Filed: Jul. 13, 2004

(51) Int. Cl. H04B 7/00; H04Q 7/20; H04M 1/00; H04B 1/38

(52) U.S. Cl. 455/567; 455/550.1

(57) ABSTRACT

A mobile communication device, such as a mobile telephone, that provides adaptive audible notifications to user. The mobile communication device is adapted to obtain information concerning the environment in which the device is located, such as ambient noise level or whether the device is in an enclosure, and to select an appropriate user notification loudness level based on the obtained information.

### BACKGROUND OF THE INVENTION

1. Field of the Invention

The present invention relates generally to mobile communication devices. In particular, the present invention relates to mobile communication devices that provide audible user notifications.

2. Background

Conventional mobile communication devices are typically capable of providing audible notifications to a user upon the occurrence of an event. For example, conventional mobile phones are configurable to ring upon receipt of an incoming call. A problem with such conventional devices is that it can be difficult to hear the notification when the user is in a noisy environment. For example, it may be difficult to hear a mobile telephone ring in a noisy room or moving vehicle. Likewise, if the communication device is stored inside an enclosure, the notification may be muffled and therefore difficult to hear. For example, it may be difficult to hear a mobile telephone ring if it is stored in a purse or a coat pocket. If the user cannot hear the notification, they may miss telephone calls or other events.

Current approaches for solving the above-described problems include providing the mobile communication device with (1) a vibrate mode, (2) a user-configurable notification loudness level, and/or (3) a ring mode in which the loudness is increased with each consecutive ring.

A problem with each of the aforementioned approaches is that they require the user to keep track of what environment the mobile communication device is in and to configure the device accordingly. Often, users forget to change the settings on their mobile communication device until after telephone calls or other events have been missed. Furthermore, changing settings on the mobile communication device can be cumbersome.

A further problem with the vibrate mode is that it requires the mobile communication device to be in physical contact with the user in order for the vibration of the device to be detected. For example, a vibrating mobile telephone in a coat pocket or purse may not be heard or felt in a noisy environment.

An additional problem with a ring mode in which the loudness is increased with each consecutive ring is that, once configured to use that mode, the mobile communication device will ring in that mode regardless of the environment in which it is located. For example, suppose that a user is in a quiet office with the mobile communication device within earshot on a desk, and for some reason does not wish to answer an incoming call. In that instance, the mobile communication device will nevertheless ring with increasing and unnecessary loudness.

What is needed then is a mobile communication device that improves upon and addresses the aforementioned shortcomings of conventional mobile communication devices.

### BRIEF SUMMARY OF THE INVENTION

The present invention is directed to a mobile communication device, such as a mobile telephone, that provides adaptive audible notifications to user. In accordance with various embodiments of the present invention, the mobile communication device is adapted to automatically obtain information concerning the environment in which the device is located, such as ambient noise level or whether the device is in an enclosure, and to select an appropriate user notification loudness level based on the obtained information.

In accordance with a further embodiment of the present invention, the mobile communication device is adapted to provide a non-audible user notification in addition to or instead of an audible user notification based on the obtained information. The non-audible user notification may comprise a vibration-based user notification or a visible user notification, such as a notification graphic or LED display.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a mobile communication device in accordance with an embodiment of the present invention.

FIG. 2 illustrates a flowchart of a method for providing adaptive audible user notifications in a mobile communication device in accordance with an embodiment of the present invention.

FIGS. 3 and 4 illustrate flowcharts of exemplary alternative methods for using ambient noise level detection to implement adaptive audible user notifications in accordance with embodiments of the present invention.

FIG. 5 illustrates a flowchart of a method for providing adaptive audible user notifications in a mobile communication device in accordance with an embodiment of the present invention.

FIG. 6 illustrates a flowchart of a method for determining whether a mobile communication device is within an enclosure in accordance with an embodiment of the present invention.

FIGS. 7 and 8 illustrate flowcharts of exemplary alternative methods for using enclosure checking to implement adaptive audible user notifications in accordance with embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

A. Mobile Communication Device in Accordance with an Embodiment of the Present Invention

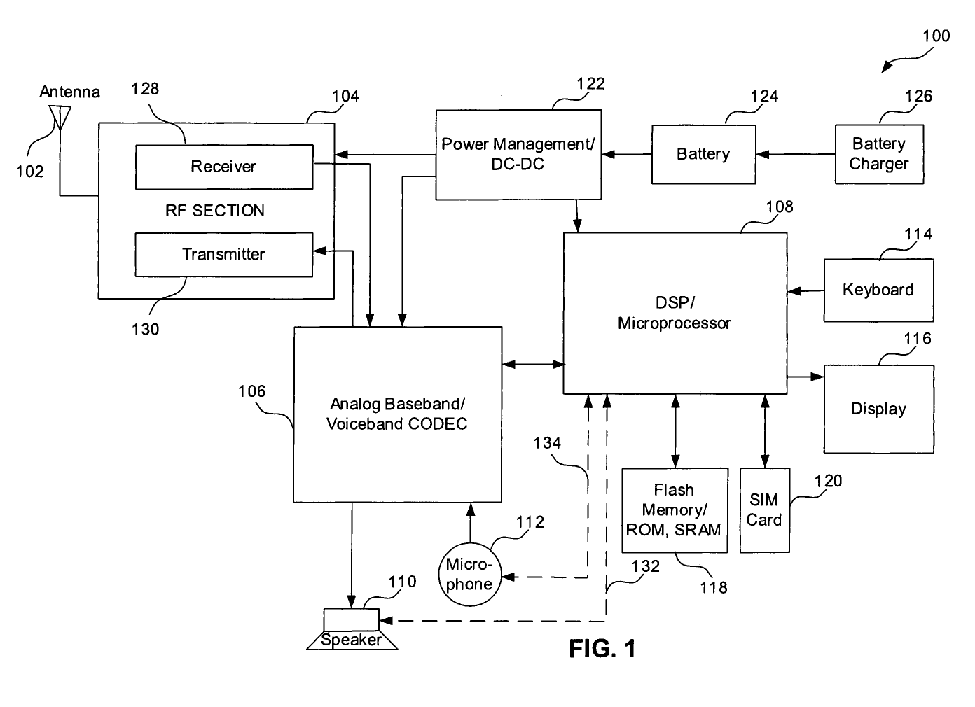

FIG. 1 is a block diagram of a mobile telephone 100 in accordance with an embodiment of the present invention. However, it should be noted that the present invention is not limited to mobile telephones, but is generally applicable to any mobile communication device capable of providing audible user notifications, including but not limited to pagers, wireless e-mail devices (such as BlackBerry™ devices), personal digital assistants, Pocket PCs, tablet PCs, laptop computers, and the like.

As shown in FIG. 1, mobile telephone 100 includes a number of electrically interconnected components including an antenna 102, a radio frequency (RF) section 104, an analog baseband/voiceband coder/decoder (CODEC) 106, a digital signal processor (DSP) and microprocessor 108, a speaker 110, a microphone 112, a keyboard 114, a display 116, a flash memory/read only memory (ROM) and synchronous random access memory (SRAM) 118, a Subscriber Identity Module (SIM) card 120, a power management/DC-DC module 122, a battery 124, and a battery charger 126.

Mobile telephone 100 is adapted for standard two-way wireless communication with a base station. The communication functionality of mobile telephone 100 may be thought of as including both a receive path and a transmit path. The receive path begins with the reception of RF signals by antenna 102. Receiver 128 of RF section 104 filters and downconverts the received RF signals to analog baseband signals for decoding by CODEC 106. To perform decoding functions, CODEC 106 filters, samples and digitizes the analog baseband signals for processing by the DSP portion of DSP/microcontroller 108. The DSP is a highly customized processor designed to perform signal manipulation calculations at high speed. Digitized speech information decoded by CODEC 106 is played back to the user via speaker 110.

In the transmit path, analog voice signals are received via microphone 112 and provided to CODEC 106, which digitizes and encodes the voice signals in accordance with an appropriate encoding scheme. Encoding is carried out in part using the DSP portion of DSP/microcontroller 108. CODEC 106 further samples and converts the encoded digital speech to analog baseband signals which are then fed to transmitter 130 of RF section 104. Transmitter 130 filters, upconverts and amplifies the analog baseband signals for transmission via antenna 102.

The user interface of mobile telephone 100 includes a keyboard 114 and display 116. The microprocessor portion of DSP/microprocessor 108 performs all housekeeping chores for keyboard 114 and display 116, deals with command and control signaling with the base station, and also coordinates the majority of the remaining functions within mobile telephone 100.

The flash memory/ROM, SRAM memory chips 118 provide storage for the operating system of mobile telephone 100 as well as other customizable features, such as a telephone directory. SIM card 120 stores the user's subscriber identification number and other network information.

Power management/DC-DC module 122 regulates from battery 124 all of the voltages required to power the different sections of mobile telephone 100. Battery charger 126 provides a means for recharging battery 124 using an external power source.

In accordance with an embodiment of the present invention, mobile telephone 100 also includes functionality for providing adaptive audible user notifications. In a first embodiment, DSP/microprocessor 108 and microphone 112 are adapted to detect the ambient noise level in the environment surrounding mobile telephone 100 and to adjust the loudness of an audible user notification based on the ambient noise level. In a second embodiment, DSP/microprocessor 108, speaker 110 and microphone 112 are adapted to determine whether mobile telephone 100 is within an enclosure and to adjust the loudness of an audible user notification based on this determination. As shown in FIG. 1, to carry out these functions, speaker 110 and microphone 112 may communicate with DSP/microprocessor 108 via CODEC 106, or, in an alternative embodiment, via a corresponding direct connections 132 and 134 (shown as dashed lines).

In accordance with a further embodiment of the present invention, DSP/microprocessor 108 and microphone 112 are adapted to detect the ambient noise level in the environment surrounding mobile telephone 100 and to provide a non-audible user notification in addition to or instead of an audible user notification, based on the ambient noise level. The non-audible user notification may comprise, for example, a vibration-based user notification or a visible user notification such as a notification graphic or LED display provided by display 116.

Each of the aforementioned embodiments will now be described in more detail.

B. Adaptive Audible User Notifications Using Ambient Noise Level Detection in Accordance with an Embodiment of the Present Invention

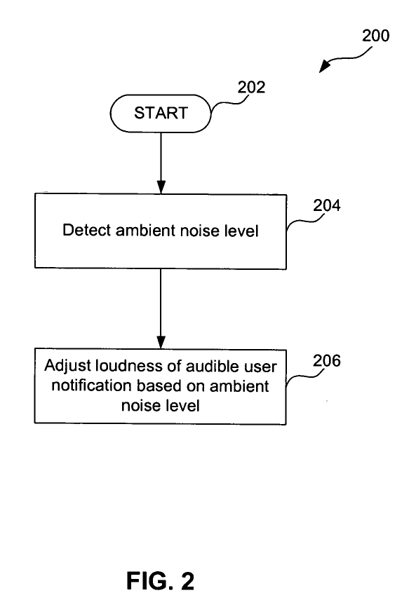

FIG. 2 illustrates a flowchart 200 of a method for providing adaptive audible user notifications in a mobile communication device in accordance with an embodiment of the present invention. The invention, however, is not limited to the description provided by the flowchart 200. Rather, it will be apparent to persons skilled in the relevant art(s) from the teachings provided herein that other functional flows are within the scope and spirit of the present invention. Flowchart 200 will be described with continued reference to example mobile telephone 100 described above in reference to FIG. 1. The invention, however, is not limited to that embodiment.

The method of flowchart 200 is initiated at step 202. At step 204, mobile telephone 100 uses its microphone 112 to detect the ambient noise level of the environment in which mobile telephone 100 is currently located. At step 206, DSP and/or microprocessor 108 within mobile telephone 100 analyzes the ambient noise level and adjusts the loudness of an audible user notification based on the ambient noise level. For example, the DSP and/or microprocessor 108 may adjust the ring loudness based on the ambient noise level. Thus, in accordance with an embodiment of the present invention, as the ambient noise level around the telephone increases, the loudness of the ring is increased accordingly.

It should be noted that, although the description provided herein describes adjusting the loudness of an audible user notification based on the ambient noise level, it is possible that a current loudness setting is already appropriate for the ambient noise level. In this instance, an embodiment of the invention will not adjust the loudness level.

In one implementation, a variety of environments are tested to determine what ring loudness allows the phone to be heard at various ambient noise levels. A look-up table is then programmed into the mobile phone 100 correlating ambient noise levels to an appropriate ring loudness. The DSP and/or microprocessor 108 accesses the look-up table and uses the determined ambient noise level to select a corresponding ring loudness. The look-up table may be stored in flash memory/ROM, SRAM 118 or other suitable memory coupled to DSP/microprocessor 108.

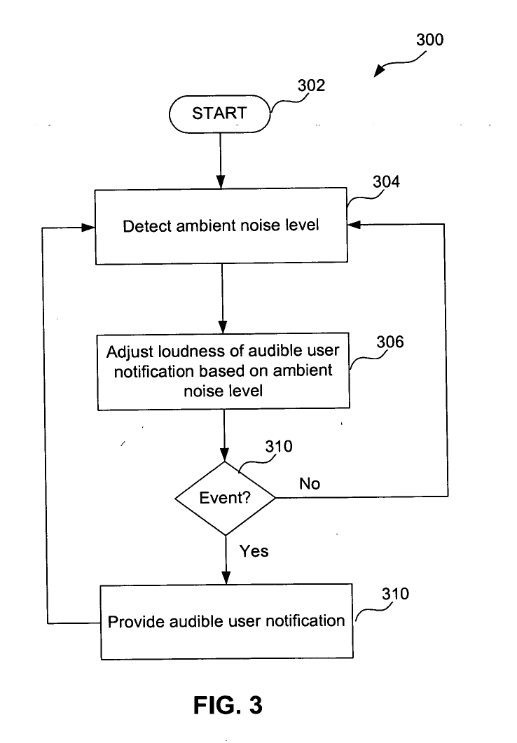

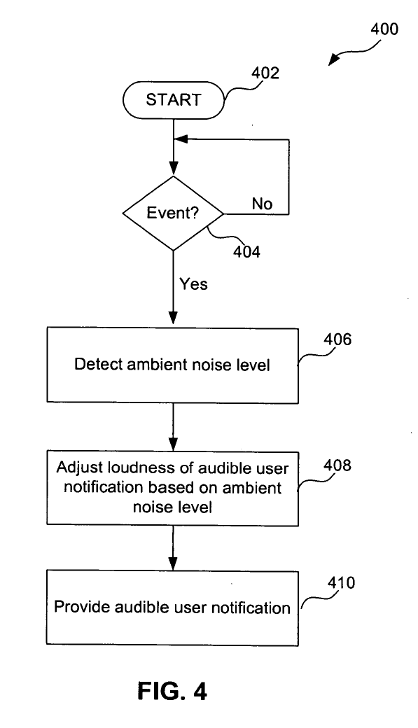

FIGS. 3 and 4 illustrate flowcharts of exemplary alternative methods for using ambient noise level detection to implement adaptive audible user notifications in accordance with embodiments of the present invention. In particular, the flowchart of FIG. 3 illustrates a method in which the ambient noise level is detected and the loudness of the audible user notification is adjusted periodically while FIG. 4 illustrates a method in which the ambient noise level is detected and the loudness of the audible user notification is adjusted only when an event occurs.

As shown in FIG. 3, the method of flowchart 300 is initiated at step 302. At step 304, mobile telephone 100 uses its microphone 112 to detect the ambient noise level of the environment in which mobile telephone 100 is currently located. At step 306, DSP and/or microprocessor 108 within mobile telephone 100 analyzes the ambient noise level and adjusts the loudness of an audible user notification based on the ambient noise level.

At decision step 308, mobile telephone 100 determines if an event has occurred. For example, mobile telephone 100 may determine if a telephone call has been received. If no event has occurred, then after a predetermined amount of time steps 304 and 306 are repeated to readjust the loudness of the audible user notification to correspond to the noise level of the environment in which mobile telephone 100 is currently located. Thus, the loudness level of the audible user notification is periodically adjusted to account for changing ambient noise conditions. When an event occurs, mobile telephone 100 provides the user with an audible user notification at the most recently adjusted loudness level.

As shown in FIG. 4, the method of flowchart 400 is initiated at step 402. At decision step 404, mobile telephone 100 determines if an event has occurred. For example, mobile telephone 100 may determine if a telephone call has been received. If no event has occurred, then mobile telephone 100 continues to wait for an event to occur, as illustrated by the “no” path extending from decision step 404.

As shown at step 406, if an event has occurred, then mobile telephone 100 uses its microphone 112 to detect the ambient noise level of the environment in which mobile telephone 100 is currently located. At step 408, DSP and/or microprocessor 108 within mobile telephone 100 analyzes the ambient noise level and adjusts the loudness of an audible user notification based on the ambient noise level. At step 410, mobile telephone 100 provides the user with an audible user notification at the adjusted loudness level. Thus, in accordance with this embodiment, the loudness level of the audible user notification is adjusted only when an event occurs.

In accordance with a further embodiment of the present invention, mobile telephone 100 uses its microphone 112 to detect the ambient noise level of the environment in which mobile telephone 100 is currently located. The DSP and/or microprocessor 108 within mobile telephone 100 then analyzes the ambient noise level and, if the ambient noise level is determined to be above a predefined level, configures mobile telephone 100 to provide a non-audible user notification. The non-audible user notification may comprise, for example, a vibration-based user notification or a visible user notification such as a notification graphic or LED display provided by display 116.

The non-audible user notification may be provided instead of or in addition to a standard audible user notification or in addition to an adaptive audible user notification, the generation of which has been described in detail elsewhere herein. By also providing adaptive non-audible user notifications, an embodiment of the present invention provides additional feedback to ensure that a user does not miss events occurring on mobile telephone 100, or on any mobile communication device. For example, in accordance with an embodiment of the present invention, when a user of mobile telephone 100 enters a noisy environment, mobile telephone 100 will automatically configure itself to provide a louder ring and to also vibrate upon the occurrence of a user event to account for the ambient noise level.

C. Adaptive Audible User Notifications Using Enclosure Checking in Accordance with an Embodiment of the Present Invention

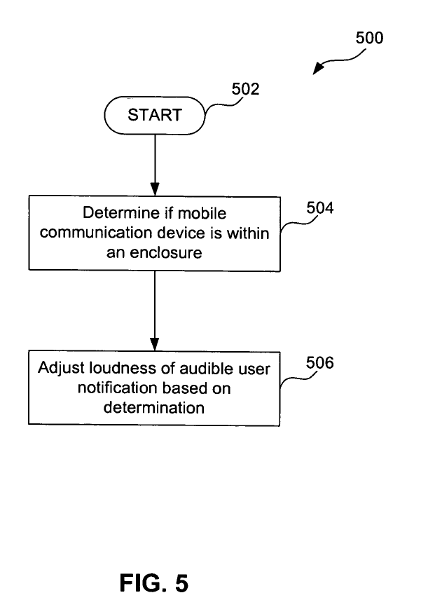

FIG. 5 illustrates a flowchart 500 of a method for providing adaptive audible user notifications in a mobile communication device in accordance with an embodiment of the present invention. The invention, however, is not limited to the description provided by the flowchart 500. Rather, it will be apparent to persons skilled in the relevant art(s) from the teachings provided herein that other functional flows are within the scope and spirit of the present invention. Flowchart 500 will be described with continued reference to example mobile telephone 100 described above in reference to FIG. 1. The invention, however, is not limited to that embodiment.

The method of flowchart 500 is initiated at step 502. At step 504, mobile telephone 100 determines if it is within an enclosure. At step 506, DSP and/or microprocessor 108 within mobile telephone 100 adjusts the loudness of an audible user notification based on the determination of whether the device is within an enclosure. For example, DSP and/or microprocessor 108 may adjust the ring loudness based on the determination of whether it is within an enclosure. Thus, in accordance with an embodiment of the present invention, if the device is confined within an enclosure such as a purse or a coat pocket, the loudness of the ring is increased accordingly.

It should be noted that, although the description provided herein describes adjusting the loudness of an audible user notification based on a determination of whether mobile telephone 100 is within an enclosure, it is possible that a current loudness setting is already appropriate for the environment in which mobile telephone 100 is located. In this instance, an embodiment of the invention will not adjust the loudness level.

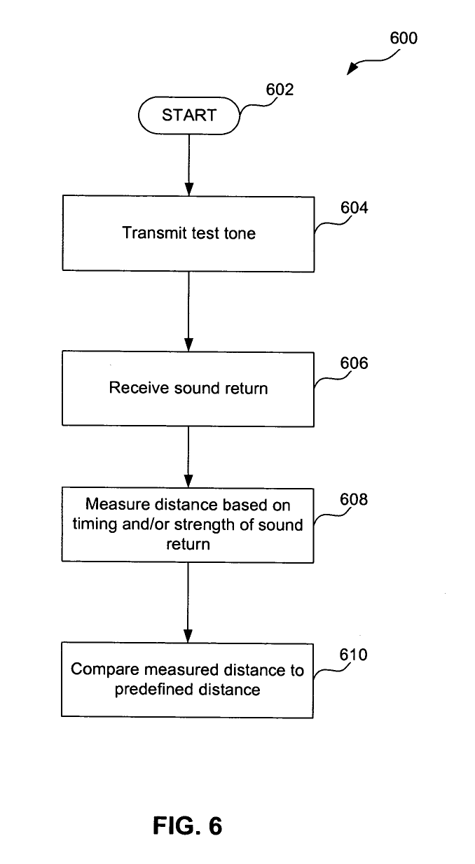

The flowchart 600 of FIG. 6 illustrates one method for determining whether mobile telephone 100 is within an enclosure, although the invention is not limited to this technique.

As shown in FIG. 6, the method of flowchart 600 is initiated at step 602. At step 604, mobile telephone 100 transmits a test tone through speaker 110. At step 606, mobile telephone 100 uses microphone 112 to receive a sound return corresponding to the test tone. At step 608, DSP and/or microprocessor 108 within mobile telephone 100 analyzes the timing and/or strength of the sound return to estimate a distance that the sound has traveled. As will be appreciated by persons skilled in the relevant art(s), any of a variety of well-known techniques for measuring distance using the timing and/or strength of a sound return may be used.

At step 610, DSP and/or microprocessor 108 compares the measured distance to a predefined distance to determine whether mobile telephone 100 is within an enclosure. For example, in an embodiment, DSP and/or microprocessor 108 determines that mobile telephone 100 is within an enclosure if the measured distance is less than a certain predefined distance.

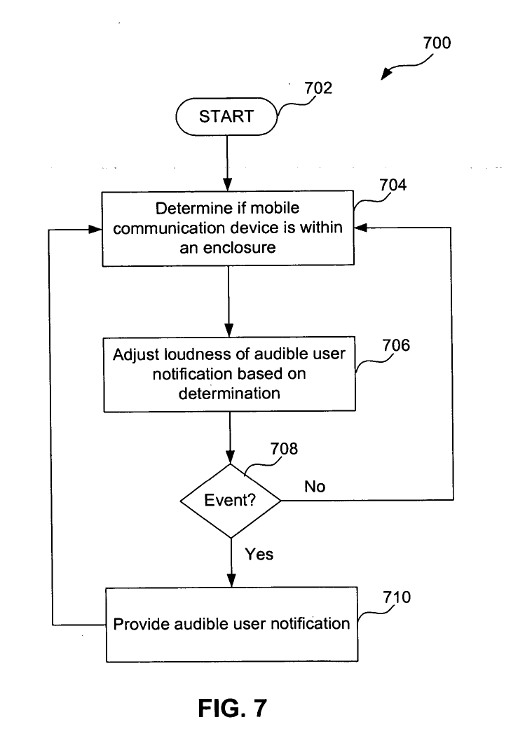

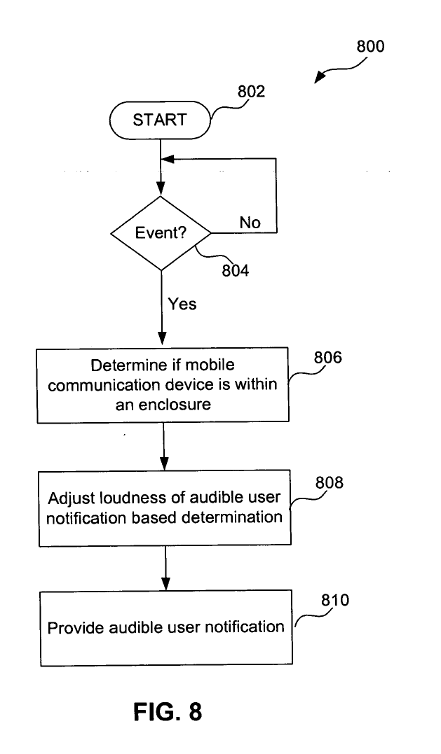

FIGS. 7 and 8 illustrate flowcharts of exemplary alternative methods for using enclosure checking to implement adaptive audible user notifications in accordance with embodiments of the present invention. In particular, FIG. 7 illustrates a method in which enclosure checking is performed and the loudness of the audible user notification is adjusted periodically while FIG. 8 illustrates a method in which enclosure checking is performed and the loudness of the audible user notification is adjusted only when an event occurs.

As shown in FIG. 7, the method of flowchart 700 is initiated at step 702. At step 704, mobile telephone 100 determines if it is within an enclosure. This may be performed, for example, by transmitting a test tone and measuring a distance based on the timing and/or strength of a sound return corresponding to the test tone as discussed above in reference to FIG. 6. At step 706, DSP and/or microprocessor 108 adjusts the loudness of an audible user notification based on the determination of whether mobile telephone 100 is within an enclosure.

At decision step 708, mobile telephone 100 determines if an event has occurred. For example, mobile telephone 100 may determine if a telephone call has been received. If no event has occurred, then after a predetermined amount of time steps 704 and 706 are repeated to readjust the loudness of the audible user notification to correspond to the environment in which mobile telephone 100 is currently located. Thus, the loudness level of the audible user notification is periodically adjusted to account for changes to the location of the device, such as insertion into or removal from an enclosure. When an event occurs, mobile telephone 100 provides the user with an audible user notification at the most recently adjusted loudness level.

As shown in FIG. 8, the method of flowchart 800 is initiated at step 802. At decision step 804, mobile telephone 100 determines if an event has occurred. For example, mobile telephone 100 may determine if a telephone call has been received. If no event has occurred, then mobile telephone 100 continues to wait for an event to occur, as illustrated by the “no” path extending from decision step 804.

As shown at step 806, if an event has occurred, then mobile telephone 100 determines if it is within an enclosure. This may be performed, for example, by transmitting a test tone and measuring a distance based on the timing and/or strength of a sound return corresponding to the test tone as discussed above in reference to FIG. 6. At step 808, DSP and/or microprocessor 108 within mobile telephone 100 adjusts the loudness of an audible user notification based on the determination of whether mobile telephone 100 is within an enclosure. At step 810, mobile telephone 100 provides the user with an audible user notification at the adjusted loudness level. Thus, in accordance with this embodiment, the loudness level of the audible user notification is adjusted only when an event occurs.

In an alternate embodiment of the method shown in flowchart 800, the first ring of the audible user notification is also used as the test tone. Thus, in accordance with this embodiment, the steps of enclosure checking and loudness adjustment are performed contemporaneously with providing the audible user notification, such that the loudness level of the audible user notification may increase or decrease as the notification is being provided to the user.

### D. CONCLUSION

While various embodiments of the present invention have been described above, it should be understood that they have been presented by way of example only, and not limitation. For example, although embodiments of the present invention have been described herein with reference to mobile telephones, the present invention is not limited to mobile telephones but is generally applicable to any mobile communication device capable of providing audible user notifications, including but not limited to pagers, wireless e-mail devices (such as BlackBerry™ devices), personal digital assistants, Pocket PCs, tablet PCs, laptop computers, and the like.

Furthermore, the present invention is not limited to any particular type of audible user notification, such as the ring notification typically associated within an incoming telephone call, but is broad enough to encompass any notification capable of being heard by a user. Additionally, the present invention is not limited to a particular type of event, such as an incoming phone call, but is broad enough to encompass any type of event about which a user may wish to be notified, including but not limited to incoming pages, e-mails, news alerts, instant messages, and the like.

Thus, it will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for providing adaptive audible user notifications in a mobile communication device, comprising:
determining an ambient noise level; and
adjusting the loudness of an audible user notification based on the ambient noise level.

2. The method of claim 1, wherein determining an ambient noise level comprises detecting ambient noise using a microphone.

3. The method of claim 1, wherein adjusting the loudness of an audible user notification based on the ambient noise level comprises accessing a lookup table that correlates ambient noise levels to notification loudness levels.

4. The method of claim 1, further comprising:
providing the audible user notification when an event has occurred.

5. The method of claim 4, wherein providing the audible user notification when an event has occurred comprises providing the audible user notification when a telephone call is received.

6. The method of claim 1, further comprising:
periodically repeating the determining and adjusting steps.

7. The method of claim 1, wherein the determining and adjusting steps are performed in response to the occurrence of an event.

8. The method of claim 1, further comprising:
determining whether to provide a non-audible user notification based on the ambient noise level.

9. The method of claim 8, wherein determining whether to provide a non-audible user notification based on the ambient noise level comprises determining whether to provide a vibration-based user notification.

10. The method of claim 9, wherein determining whether to provide a non-audible user notification comprises determining whether to provide a visual user notification.

11. A mobile communication device, comprising:
a microphone;
a processor coupled to the microphone, the processor configured to receive ambient noise level information from the microphone and to adjust the loudness of an audible user notification based on the ambient noise level information.

12. The mobile communication device of claim 11, wherein the mobile communication device comprises a mobile telephone.

13. The mobile communication device of claim 11, further comprising:
a memory that stores a lookup table correlating ambient noise levels to notification loudness levels;
wherein the processor is configured to adjust the loudness of the audible user notification based on the ambient noise level information by accessing the lookup table.

14. The mobile communication device of claim 11, wherein the processor is further configured to provide the audible user notification when an event has occurred.

15. The mobile communication device of claim 11, wherein the processor is configured to periodically adjust the loudness of the audible user notification based on updated ambient noise level information from the microphone.

16. The mobile communication device of claim 11, wherein the processor is configured to adjust the loudness of the audible user notification based on the ambient noise level in response to the occurrence of an event.

17. The mobile communication device of claim 11, wherein the processor is further configured to determine whether to provide a non-audible user notification based on the ambient noise level information.

18. The mobile communication device of claim 17, wherein the processor is configured to determine whether to provide a vibration-based user notification.

19. The mobile communication device of claim 17, wherein the processor is configured to determine whether to provide a visible user notification.

20. A method for providing adaptive audible user notifications in a mobile communication device, comprising:
determining if the mobile communication device is within an enclosure; and
adjusting the loudness of an audible user notification based on the determination.

21. The method of claim 20, wherein determining if the mobile communication device is within an enclosure comprises:
transmitting a test tone;
receiving a sound return corresponding to the test tone; and
evaluating the timing and/or strength of the sound return.

22. The method of claim 21, wherein transmitting a test tone comprises transmitting a test tone via a speaker.

23. The method of claim 21, wherein receiving a sound return corresponding to the test tone comprises receiving a sound return corresponding to the test tone via a microphone.

24. The method of claim 21, wherein the audible user notification serves as the test tone.

25. The method of claim 20, further comprising:
providing the audible user notification in response to the occurrence of an event.

26. The method of claim 25, wherein providing the audible user notification in response to the occurrence of an event comprises providing the audible user notification in response to receiving a telephone call.

27. The method of claim 20, further comprising:
periodically repeating the determining and adjusting steps.

28. The method of claim 20, wherein the determining and adjusting steps are performed in response to the occurrence of an event.

29. A mobile communication device, comprising:
a microphone;
a speaker; and
a processor coupled to the microphone and speaker, the processor configured to transmit a test tone via the speaker and to receive a sound return corresponding to the test tone via the microphone;
wherein the processor is further configured to analyze the sound return to determine if the mobile communication device is within an enclosure and to adjust the loudness of an audible user notification based on the determination.

30. The mobile communication device of claim 29, wherein the mobile communication device comprises a mobile telephone.

31. The mobile communication device of claim 29, wherein the processor is configured to determine if the mobile communication device is within an enclosure by evaluating the strength of the sound return.

32. The mobile communication device of claim 29, wherein the processor is configured to determine if the mobile communication device is within an enclosure by evaluating the timing of the sound return.

33. The mobile communication device of claim 29, wherein the processor is further configured to provide the audible user notification in response to the occurrence of an event.

34. The mobile communication device of claim 29, wherein the processor is configured to periodically adjust the loudness of the audible user notification based on an updated determination of whether the mobile communication device is within an enclosure.

35. The mobile communication device of claim 29, wherein the processor is configured to adjust the loudness of the audible user notification based on the determination in response to the occurrence of an event.

36. The mobile communication device of claim 29, wherein the audible user notification serves as the test tone.

37. A method for providing adaptive non-audible user notifications in a mobile communication device, comprising:
determining an ambient noise level; and
determining whether to provide a non-audible user notification based on the ambient noise level.

38. The method of claim 31, wherein determining whether to provide a non-audible user notification based on the ambient noise level comprises determining whether to provide a vibration-based user notification.

39. The method of claim 31, wherein determining whether to provide a non-audible user notification based on the ambient noise level comprises determining whether to provide a visible user notification.
